(19) United States
(12) Patent Application Publication
(10) Pub. No.: US 2014/0091976 A1
(43) Pub. Date: Apr. 3, 2014

(54) Antennas and Transceiver for UHF Wireless Communications

(71) Applicant: James Carlson, Eureka, CA (US)

(72) Inventor: James Carlson, Eureka, CA (US)

(73) Assignee: Carlson Wireless Technologies, Inc.

(21) Appl. No.: 13/633,000

(22) Filed: Oct. 1, 2012

(51) Int. Cl. H01Q 9/28; H01Q 9/18

(52) U.S. Cl. CPC H01Q 9/28; H01Q 9/18
USPC 343/795

(57) ABSTRACT

Improved antennas and a transceiver for UHF wireless communications are disclosed.

### TECHNICAL FIELD

Improved antennas and a transceiver for UHF wireless communications are disclosed.

### BACKGROUND OF THE INVENTION

Broadcast analog TV in the UHF bandwidth is well-known in the art. Due to the migration from analog to digital TV, that allows channels to be adjacent, stations were able to relocate and pack together into the upper VHF and lower UHF portions of the spectrum. The areas abandoned are often referred to as “TV White Space.”

Various antenna designs also are well-known in the art. Examples of antenna structures include cylindrical dipoles, biconical dipoles, and log-periodic antennas.

Transceivers for use with antennas also are well-known in the art.

However, in the past, the UHF bandwidth has not been used for purposes other than analog TV broadcast. TV transmission equipment and their antennas are designed for extremely large amounts of power. What is needed is improved antennas and transceivers that are suitable for broadcasting other content—such as data and voice communication—over the UHF bandwidth using dramatically less power than broadcast TV.

### SUMMARY OF THE INVENTION

The aforementioned problems and needs are addressed by two novel antenna designs particularly suited for UHF communication and an improved transceiver for use with those antennas.

### BRIEF DESCRIPTION OF THE DRAWINGS

FIG. 1 depicts the complete omnidirectional antenna assembly without its protective housing.

FIG. 2 depicts the complete omnidirectional antenna assembly 10 with housing 80 being a polycarbonate sunlight resistant weatherproof housing. The adaptive mount to fix the housing to a vertical mast is made of structural aluminum. Upper 82 and lower 81 end caps are used to prevent weather from entering.

FIG. 3 depicts a close up view of the lower dipole 20.

FIG. 4 depicts a log periodic antenna embodiment.

FIG. 5 depicts a block diagram of a transceiver and antenna.

FIG. 6 depicts an embodiment of an output stage of a transceiver.

### DETAILED DESCRIPTION OF THE PREFERRED EMBODIMENTS

Two antenna embodiments and one transceiver embodiment will now be described.

### Cylindrical-Biconical Hybrid Antenna Embodiment

Cylindrical antennas are known in the art. Biconical antennas also are known in the art. However, the applicants have found that a novel cylindrical-biconical hybrid antenna is particularly well-suited for UHF communication.

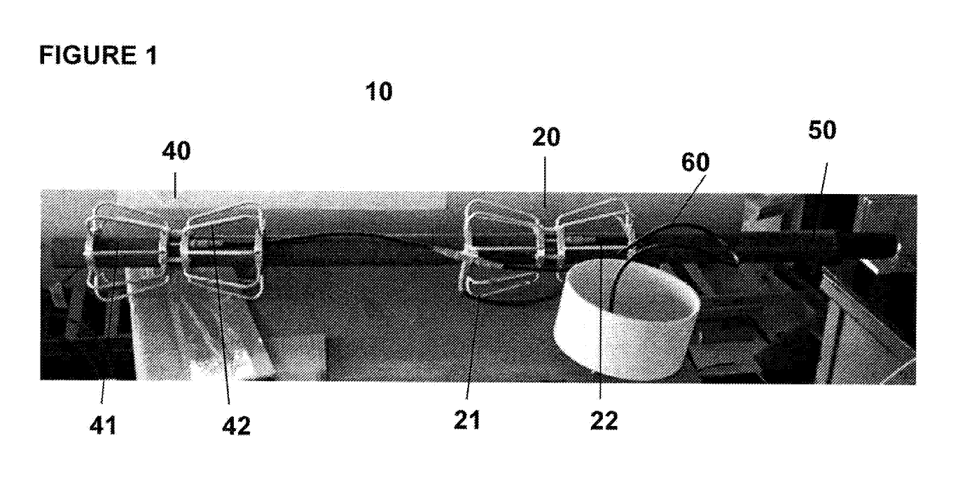

An embodiment is shown in FIG. 1. Hybrid antenna 10 is an omni-directional antenna, which means that it radiates in the E-plane in all 360 degrees. Hybrid antenna 10 is capable of producing close to the ideal 6 dBi gain on the transmitted and received signal and can do such with a very wide radio frequency bandwidth. Hybrid antenna 10 is vertically polarized.

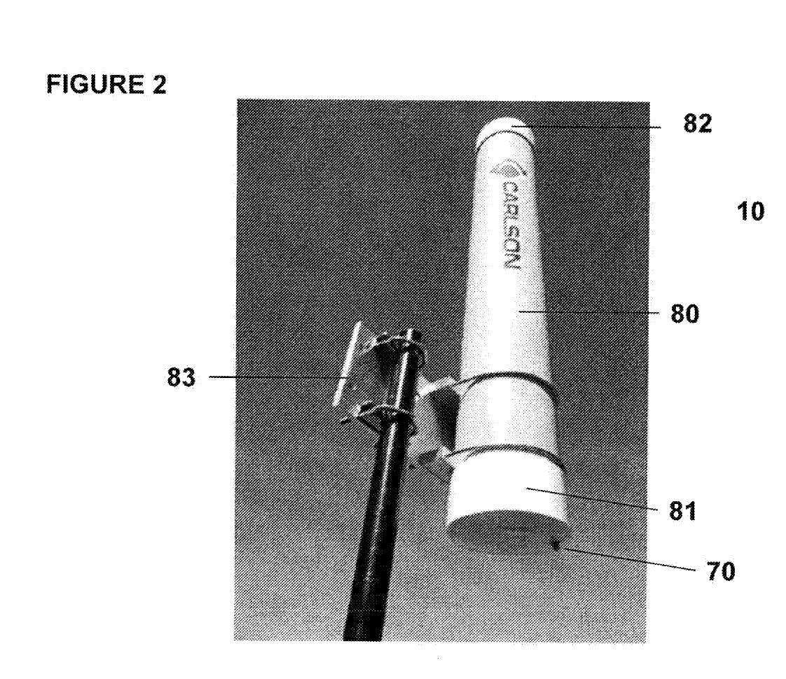

Hybrid antenna 10 comprises two sets of dipoles 20 and 40. Dipole 20 comprises upper structure 21 and lower structure 22. Dipole 40 comprises upper structure 41 and lower structure 42. Dipoles 20 and 40 are mounted upon center pole 50. Center pole 50 is constructed from a non-conductive material such as fiberglass. Antenna lead 60 runs within or along center pole 50. Antenna lead 60 comprises a conductive material, such as a coaxial cable. Antenna lead is coupled to connector 70 (shown in FIG. 2), which is coupled to center pole 50. Connector 70 is used to connect to a transceiver (not shown).

With reference now to FIG. 2, optionally, protective housing 80 surrounds all of the other components, and end caps 81 and 82 cover the openings on protective housing 80. Protective housing 80 and end caps 81 and 82 are constructed from a non-conductive material such as PVC. Protective housing 80 optionally is connected to mounting device 83, such as a clamp, which can be used to mount the entire structure onto a fixed device, such as a telephone pole.

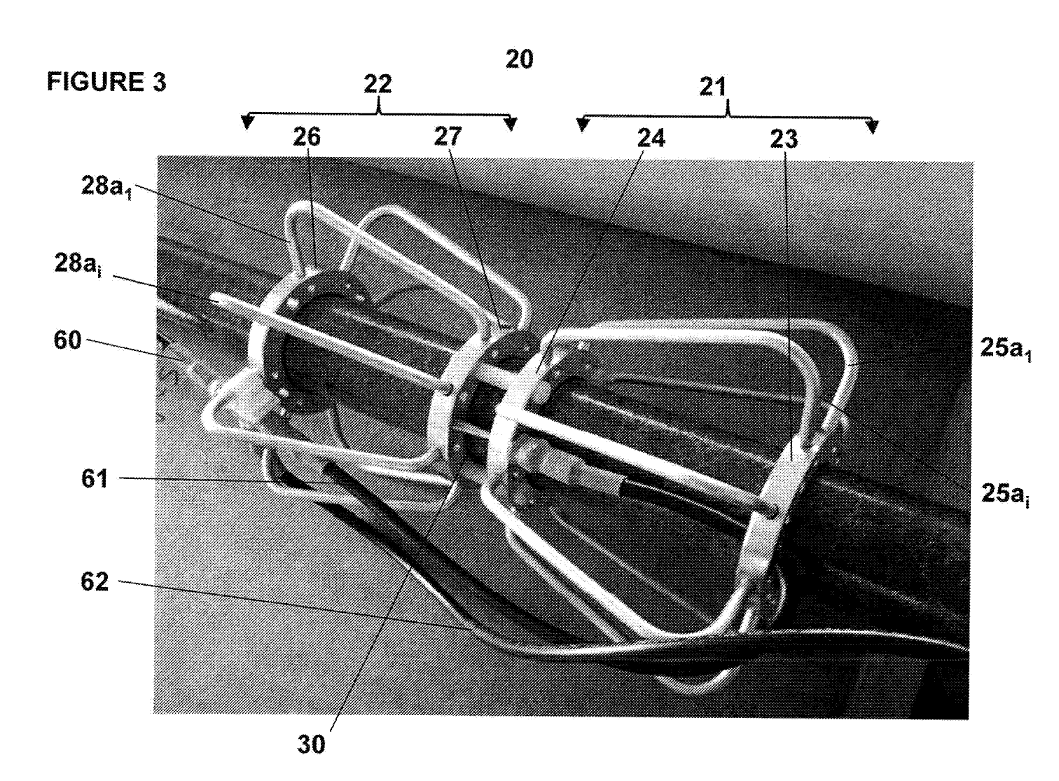

The components of dipole 20 will now be described with FIG. 3. The antenna lead 60 is coupled to segment 61 and segment 62 in a lossless fashion (negligible loss in power). Segment 61 is coupled to dipole 20, and segment 62 is coupled to dipole 40.

Lower structure 21 comprises outer ring 23 and inner ring 24. Lower structure 21 further comprises elements 25a₁ . . . 25aᵢ. Upper structure 22 comprises outer ring 26 and inner ring 27. Upper structure 22 comprises elements 28a₁ . . . 28aᵢ.

In the embodiment shown in FIG. 3, i=8. One of ordinary skill in the art will understand that i can be set to other values. Dipole 20 includes connector to feed point 30 to which segment 61 is coupled.

As can be seen in FIG. 3, dipole 20 has characteristics of a cylinder antenna as well as a biconical antenna. The distance between elements 25a₁ . . . 25aᵢ . . . and 28a₁ . . . 28aᵢ and the center pole gradually increases from the center of dipole 20 to the outer edges of dipole 20. Specifically, the radius of the center of the center pole to the outer edge of each of the first plurality of elements and second plurality of elements varies from 2.85 inches to 1.65 inches. The span in distance between the elements and center pole corresponds to the span in frequencies that can be effectively transmitted and received by dipole 20.

Dipole 40 is identical in design as dipole 20, except that it connects to segment 62 instead of segment 61.

The distance between the center of dipole 20 and the center of dipole 40 is equal to the wavelength of the median frequency of the intended spectrum.

As can be seen, dipole 20 and dipole 40 each is a cylindrical, biconical hybrid. Outer ring 23, inner ring 24, outer ring 26, and inner ring 27 in dipole 20 and the corresponding parts in dipole 40 are characteristics of a cylindrical antenna. Elements 28a₁ . . . 28aᵢ and elements 25a₁ . . . 25aᵢ in dipole 20 and the corresponding parts in dipole 40 are characteristics of a biconical antenna.

The applicants have confirmed that the disclosed embodiment is capable of transmitting and receiving a bandwidth of 470 MHz to 800 MHz with a gain approaching 6 dB over an isotropic antenna.

### Log-Periodic Antenna Embodiment

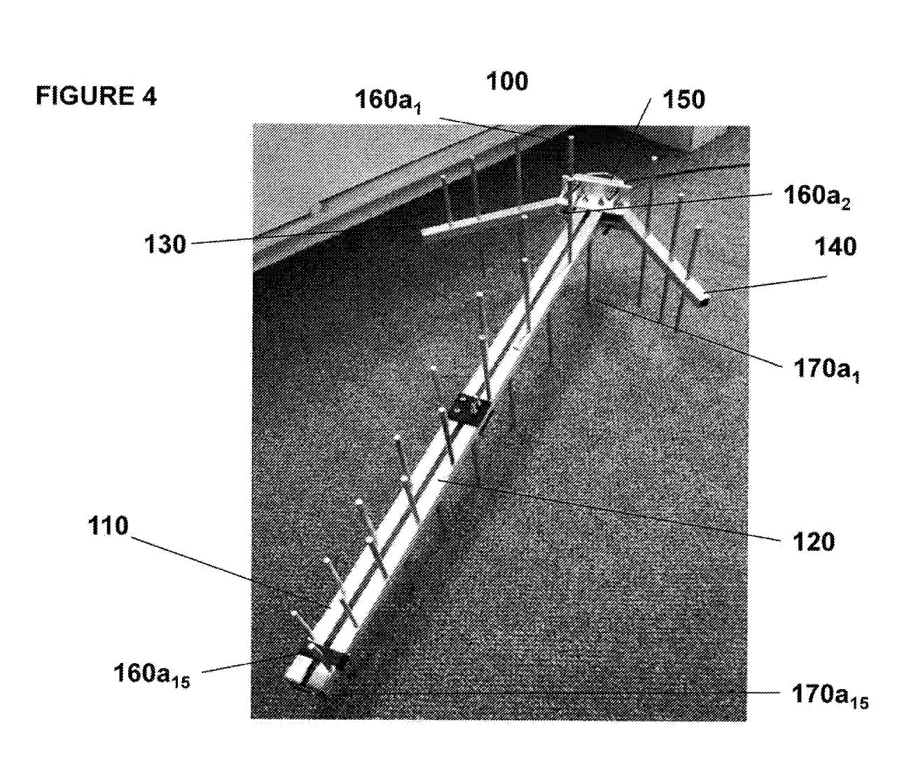

FIG. 4 depicts an embodiment of a modified log periodic antenna. The modified log periodic antenna 100 comprises boom 110 and boom 120, reflector 130, reflector 140, and shunt 150. Boom 110, boom 120, reflector 130, and reflector 140 are constructed out of a conductive material, such as aluminum. Log periodic antenna will transmit UHF signals in a sector of approximately 90 degrees, with boom 110 and boom 120 in the middle of the sector and reflector 130 and reflector 140 forming the edges of the sector.

Boom 110 and boom 120 contains elements 160a₁ . . . 160aᵢ. In this particular example, i=15. One of ordinary skill in the art will understand that i can be set to other values. Elements 160a₁ . . . 160aᵢ transmit and receive UHF signals. The height and relative placement of elements 160a₁ . . . 160aᵢ affect the properties of the antenna.

For this embodiment, Table 1 contains the height and relative placement of each element 160a₁ . . . 160a₁₅:

TABLE 1

| | Distance From Shunt 150 | |
|---|---|---|
| Element | (In Inches) | Height (In Inches) |
| 160 a₁ | 3.125 | 7.350 |
| 160 a₂ | 7.625 | 6.987 |
| 160 a₃ | 11.875 | 6.644 |
| 160 a₄ | 15.875 | 6.320 |
| 160 a₅ | 19.625 | 6.013 |
| 160 a₆ | 23.25 | 5.724 |
| 160 a₇ | 26.625 | 5.450 |
| 160 a₈ | 29.75 | 5.192 |
| 160 a₉ | 32.75 | 4.948 |
| 160 a₁₀ | 35.625 | 4.717 |
| 160 a₁₁ | 38.25 | 4.499 |
| 160 a₁₂ | 40.75 | 4.292 |
| 160 a₁₃ | 43.25 | 4.098 |
| 160 a₁₄ | 45.5 | 3.913 |
| 160 a₁₅ | 47.625 | 3.739 |

One of skill in the art will appreciate that the heights shown in Table 1 correspond to an average tau value of 0.945.

As can be seen in FIG. 4, in this embodiment, the placement of elements alternates between the top side of boom 110 and the top side of boom 120 as you travel away from shunt 50. For example, element 160a, is located on boom 110, element 160 a₂ is located on boom 120, etc. Elements 170a₁ . . . 170aᵢ (where i=15) are located on the bottom side of boom 110 and the bottom side of boom 120. The height and relative spacing for elements 170a₁ . . . 170aᵢ is the same as for elements 160a₁ . . . 160aᵢ, except that each element is placed on the other boom. For example, element 160a₁ is located on boom 110, but element 170a₁ is located on boom 120.

The inventors have built and tested this embodiment. It is capable of transmitting and receiving frequencies in the range 450-800 MHz in a sector of approximately 90 degrees with a gain of approximately 10 dBi over an isotropic antenna.

### Transceiver Embodiment

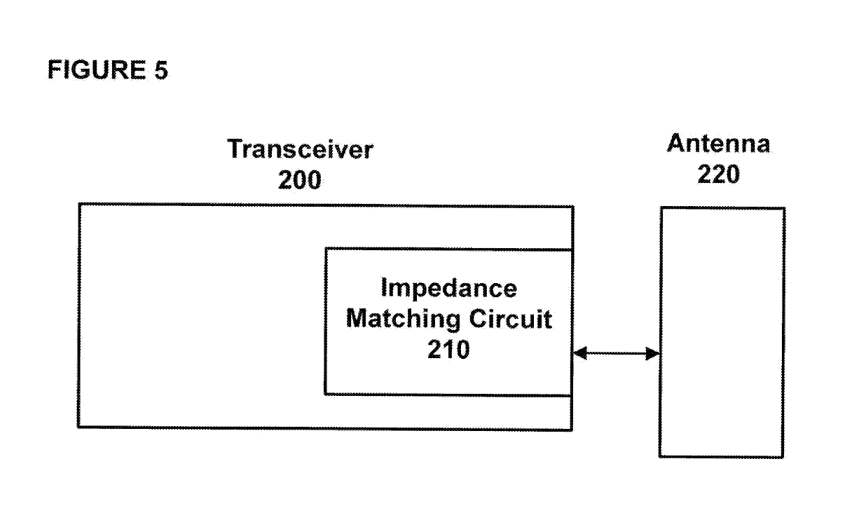

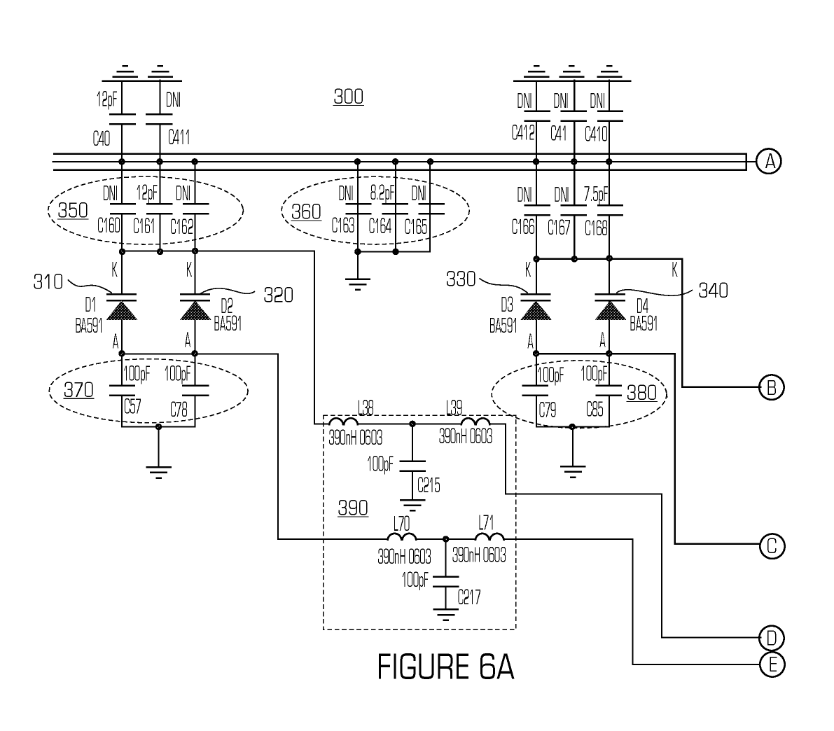

FIG. 5 depicts transceiver 200 coupled to antenna 220. Antenna 220 can be any of the antenna embodiments described herein or can be a different antenna. Transceiver 200 transmits and receives UHF signals. Transceiver 200 comprises impedance matching circuit 210. One of ordinary skill in the art will appreciate that to optimize power when transmitting, it is ideal for the output impedance of transceiver 200 to equal the input impedance of antenna 220.

One embodiment is an input impedance matching circuit 210 that is well-suited for the full bandwidth of the TV broadcast band used for UHF transmission.

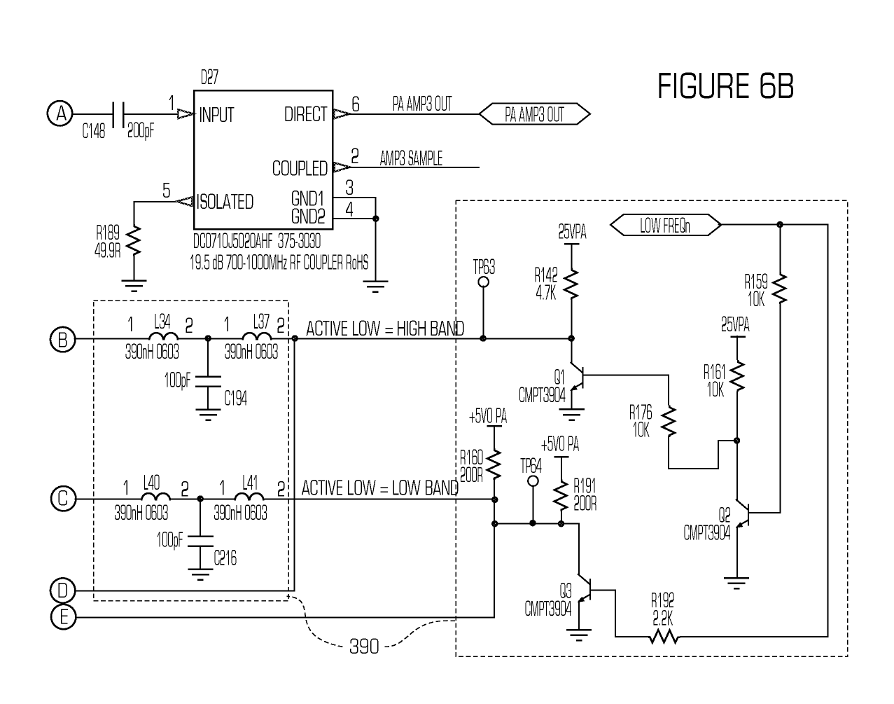

Impedance matching circuit 210 is shown in greater detail in FIG. 6. FIG. 6 shows the output section of the final power amplifying circuit.

The allowable emissions on radio frequencies outside the intended area of transmission (channel) are very restricted by federal regulations and the FCC, and thus, the matching requirements in the amplification section need to be heroic to obtain level power over bandwidth. A method is needed to add and subtract matching capacitance at the correct phase location according to transmit frequency selected. A process of experimentation with RF tuning diodes, high Q capacitors and forward and back-biased voltages was done to determine a method that would be successful in achieving the correct match over the band. An embodiment is depicted in FIG. 6.

FIG. 6 depicts back-biased diodes 310, 320, 330, and 340. Each of these diodes is coupled to UHF output 300 (which emerges from a transceiver, not shown). Capacitors 350 are coupled between UHF output 300 and back-biased diode 310 and back-biased diode 320. Capacitors 360 are coupled between UHF output 300 and back-biased diode 330 and back-biased diode 340. Capacitors 370 are coupled between back-biased diode 310 and back-biased diode 320 and ground. Capacitors 380 are coupled between back-biased diode 330 and back-biased diode 340 and ground.

The default setting for back-biased diodes 310, 320, 330, and 340 is to be in an “off” state. Each will be turned “on” if a certain voltage is placed between it and capacitors 350 and 360. Those voltages will be placed there by frequency sensing circuit 390 based on the frequency of UHF output 300. The frequencies that will turn each diode “on” is shown in Table 2:

TABLE 2

| Diode | Frequency Range to Turn “On” |
|---|---|
| 310 | 540 MHz and below |
| 320 | 540 MHz and below |
| 330 | 560 MHz and below |
| 340 | 560 MHz and below |

When a diode is turned “on,” the path between UHF output 300 and ground will become conductive through that diode, and capacitors therefore will be coupled to UHF output 300. For example, when diode 310 is turned on, capacitors 350 and 370 will become coupled to UHF output 300. This will add matching capacitance at the correct phase location according to the transmit frequency that is sensed by frequency sensing circuit 390.

In the foregoing description, various methods and apparatus, and specific embodiments are described. However, it should be obvious to one conversant in the art, various alternatives, modifications, and changes may be possible without departing from the spirit and the scope of the invention which is defined by the metes and bounds of the appended claims.

1. An antenna for transmitting and receiving wireless signals, comprising:
a center pole;
a first dipole mounted on the center pole, wherein the first dipole is a cylindrical biconical hybrid comprising a first plurality of elements and a second plurality of elements;
a second dipole mounted on the center pole, wherein the second dipole is a cylindrical biconical hybrid comprising a third plurality of elements and a fourth plurality of elements;
an antenna lead coupled to the first dipole and second dipole;
wherein the first dipole and second dipole are capable of transmitting and receiving wireless signals in the frequency range 450 MHz to 800 MHz.

2. The antenna of claim 1, wherein the antenna is vertically polarized.

3. The antenna of claim 1, further comprising a housing around the center pole, first dipole, and second dipole.

4. The antenna of claim 1, wherein the first dipole comprises an upper ring connected to the first plurality of elements and a lower ring connected to the first plurality of elements.

5. The antenna of claim 4, wherein the second dipole comprises an upper ring connected to the third plurality of elements and a lower ring connected to the third plurality of elements.

6. The antenna of claim 1, wherein the distance between the center of the first dipole and the center of the second dipole is approximately one wavelength of a center frequency of a carrier signal used in conjunction with the antenna.

7. The antenna of claim 1, wherein the radius of the center of the center pole to the outer edge of each of the first plurality of elements, second plurality of elements, third plurality of elements, and fourth plurality of elements varies from 2.85 inches to 1.65 inches.

8. The antenna of claim 5, wherein the antenna lead is contained within the center pole.

9. The antenna of claim 5, wherein the radius of the center of the center pole to the outer edge of each of the first plurality of elements, second plurality of elements, third plurality of elements, and fourth plurality of elements varies from 2.85 inches to 1.65 inches.

10. The antenna of claim 1, wherein the antenna is capable of transmitting wireless signals with a gain of 6 dB over an isotropic antenna.

11. An antenna for transmitting and receiving wireless signals, comprising:
a center pole;
a first dipole comprising a first structure mounted on the center pole, wherein the first structure comprises a first ring, a second ring, and a first plurality of elements connected to the first ring and the second ring, and a second structure mounted on the center pole, wherein the second structure comprises a third ring, a fourth ring, and a second plurality of elements connected to the third ring and the fourth ring;
a second dipole comprising a third structure mounted on the center pole, wherein the third structure comprises a fifth ring, a sixth ring, and a third plurality of elements connected to the fifth ring and the sixth ring, and a fourth structure mounted on the center pole, wherein the fourth structure comprises a seventh ring, an eighth ring, and a fourth plurality of elements connected to the seventh ring and the eighth ring;
an antenna lead coupled to the first dipole and second dipole;
wherein the radius of the center of the center pole to the outer edge of each of the first plurality of elements increases from the center of the first structure to the outer edge of the first structure;
wherein the radius of the center of the center pole to the outer edge of each of the second plurality of elements increases from the center of the second structure to the outer edge of the second structure;
wherein the radius of the center of the center pole to the outer edge of each of the third plurality of elements increases from the center of the third structure to the outer edge of the third structure; and
wherein the radius of the center of the center pole to the outer edge of each of the fourth plurality of elements increases from the center of the fourth structure to the outer edge of the fourth structure.

12. The antenna of claim 11, wherein the antenna is vertically polarized.

13. The antenna of claim 11, further comprising a housing around the center pole, first dipole, and second dipole.

14. The antenna of claim 11, wherein the distance between the center of first dipole and the center of the second dipole is approximately one wavelength of a center frequency of a carrier signal used in conjunction with the antenna.

15. The antenna of claim 11, wherein the radius of the center of the center pole to the outer edge of each of the first plurality of elements, second plurality of elements, third plurality of elements, and fourth plurality of element varies from 2.85 inches. to 1.65 inches.

16. The antenna of claim 11, further comprising an antenna lead in the center pole.

17. The antenna of claim 13, further comprising a plurality of end caps.

18. The antenna of claim 11, wherein the first plurality of elements, second plurality of elements, third plurality of elements, and fourth plurality of element are constructed from aluminum.

19. The antenna of claim 11, wherein the first dipole and second dipole are capable of transmitting and receiving wireless signals in the frequency range 450 MHz to 800 MHz.

20. The antenna of claim 11, wherein the antenna is capable of transmitting wireless signals with a gain of 6 dB over an isotropic antenna.
